(19) United States
(12) Patent Application Publication
(10) Pub. No.: US 2008/0161051 A1
(43) Pub. Date: Jul. 3, 2008

(54) Module for Data Transmission and Peripheral Device for Holding the Module

(75) Inventors: Kai Ruediger Schobbert, Erlangen (DE); Michael Wiedeking, Erlangen (DE); Detlef Buchholz, Buckenhof (DE)

Correspondence Address: KANESAKA BERNER AND PARTNERS LLP, 1700 DIAGONAL RD, SUITE 310, ALEXANDRIA, VA, 22314-2848, US

(73) Assignees: Ralph Mayr, Fuerth (DE); Kai Ruediger Schobbert, Erlangen (DE); Michael Wiedeking, Erlangen (DE)

(21) Appl. No.: 11/793,307

(22) PCT Filed: Dec. 14, 2005
(86) PCT No.: PCT/EP2005/013441

§ 371 Date: Aug. 24, 2007

(30) Foreign Application Priority Data
Dec. 21, 2004 (DE) 10 2004 062 869.6

(51) Int. Cl. H04M 1/00

(52) U.S. Cl. 455/558

(57) ABSTRACT

The invention relates to a data transmission module which comprises a first central processing unit CPU1 (1), a first memory unit (3) interacting with the CPU1 (1) and comprising a multi-layer operating system (SI, 52, S3), a transceiver (2) for the wireless data exchange with a network comprising a plurality of additional transceivers. The transceiver (2) comprises a predetermined data transmission protocol which requires identification data for identifying a user in the network, said data being stored in a second memory unit (5) in a counterfeit-proof manner. The module finally comprises a first interface (6), adapted to establish a plug-in connection, for connection to a peripheral device.

The invention relates to a module for data transmission as well as a peripheral device for holding the module.

In the prior art, a plurality of different cards or modules is known for use with peripheral devices, in particular with personal computers. Such modules have an interface shaped like a plug connector and can be connected to the peripheral device for exchanging data with each other by plugging into a further corresponding interface provided there.

Such modules provide certain additional functions to a peripheral device equipped with them. For example, a GPS module permits the transmitting and receiving of satellite data as well as the determination of a position on the surface of the earth. A GSM or a UMTS module permits wireless data transmission, in particular for communication with a telecommunications network, the Internet or similar. Such modules only represent a hardware expansion of a peripheral device. In other words they are not able to function independently without the peripheral device. Driver programs are required to implement a functional coupling to the peripheral device. The power supply of such modules is provided by the peripheral device.

In addition, in the prior art, mobile telephones, PDAs, MP3 Players and similar are known. These are data processing units with which personal data can be stored. For example, such data can be transmitted to a personal computer via an IR interface, Bluetooth or via a cable connection. The aforementioned devices are usually equipped with their own power supply and can be operated independently, if necessary without connection to a personal computer.

If, for example, personal data as well as addresses, telephone numbers and similar are stored on a mobile telephone or a PDA, the problem of data synchronization occurs in actual practice. In other words, data that have been newly entered or changed on one of the devices are not easily available to the other device so that the data on the devices may differ from each other. As per the state of technology, there are indeed programs for synchronization which are known. However, in actual practice technical problems with data synchronization occur time and time again, in particular when devices of different manufacturers are used.

WO 2004/055635 A2 describes a module for data transmission with a first central processor unit and a first memory unit which works together with the first processor unit, as well as an operating system. Furthermore, the known module comprises a transmitting and receiving unit for wireless data exchange with a peripheral device. A SIM card can be used in the known module. Using the known module, for example, the data stored thereon can be transferred to another peripheral device via the transmitting and receiving unit for synchronization. But it is not possible with the known module to establish a connection for data exchange with a mobile radio network.

The user must identify himself before he can use a mobile telephone communications network and similar. This is done by transmitting the identification data which, in particular in case of mobile telephones, are stored forgery-proof in the memory on a SIM card. Particularly in case of a personal computer when its hard drive is defective, for example, this information must be exchanged, the operating system must be installed again which means that the identification data must also be entered again. And, in such cases, the user may have misplaced the identification data. Obtaining new identification data is expensive and time-consuming.

WO 2004/006600 A1 discloses a radio module which can be used both as a modem and as a modem with additional functions in a telecommunications transmission device. An operating system provided for this handles the configuration of the connection pins of the modem. In itself, the known radio module is not suitable for establishing a connection for wireless data exchange with a mobile telecommunications network.

In the prior art, mobile telephones are known which are equipped with a camera. Use of such mobile telephones at the workplace is being increasingly banned by businesses due to the opening up of opportunities for industrial espionage. For this reason, employees frequently take mobile telephones to work which are not equipped with a camera. After closing time they then switch to another mobile telephone which is equipped with a camera. This means that the SIM card also has to be exchanged. Keeping several mobile telephones and changing the SIM card is expensive and time-consuming.

The object of the invention is to specify as universal a device as possible with which the disadvantages in the prior art are removed.

This object is resolved by the features of claims 1, 22 and 33. Useful embodiments of the invention result from the features of claims 2 to 21 and 23 to 32 and 34.

According to the invention, a module for data transmission is provided with

a first central processor unit CPU1,

a first memory unit with a multi-layer operating system, working together with CPU1,

a transmitting and receiving unit for the wireless data exchange with a network comprising a plurality of additional transmitting and receiving units,

wherein the transmitting and receiving unit comprises a specified data transmission protocol which requires identification data stored forgery-proof in a second memory unit for the identification of a user in the network, and

a first interface suitable for the establishment of a plug connection for the connection to a peripheral device.

In the sense of this invention, a “module” is understood to mean a component which by itself does not comprise a data input or output device, for example, a keyboard, a display or similar. But the module can be connected detachably with a correspondingly formed peripheral device which, for example, comprises a keyboard or a display.

In the sense of this invention, a “multi-layer operating system” is understood to mean an operating system which allows the user to change settings, enter data, edit data and similar. A user interface is thus provided which, for example, is equipped with user-friendly menu navigation. Utilization of the user interface only requires the combination of the module provided by the invention with a display and a user interface, for example, a keyboard or similar. With the multi-layer operating system, this can, for example, be an operating system which is used conventionally in the area of mobile telephones.

The suggested module for data transmission is extremely universal. For example, in combination with a simple and inexpensive housing equipped only with a keyboard, a display, a microphone, a loudspeaker and a power supply unit, it is suitable for use as a mobile telephone. The multi-layer operating system provided in the suggested module permits conventional operation of the mobile telephone as well as entering, changing or deleting of personal data. The personal data can be permanently stored via the first memory unit on the module.

The module can also be combined with other peripheral devices. For example, the module can be combined with a personal computer so that this can be used for wireless transmitting and receiving of data. This offers a simple way to establish a connection to the Internet, for example.

The module can independently receive and also transmit data even without connection to a peripheral device. Such procedures can be recognized at a later time by connection to a peripheral device.

Furthermore the module, in particular the transmitting and receiving unit, comprises a data transmission protocol which requires identification data of a user in the network, for example, in a mobile radio network. A means of reading out the identification data stored forgery-proof on a second memory unit can be provided for this. In combination with the identification data, the data transmission protocol enables the establishment of a connection to the network and thus a data exchange. The means of reading out the identification data stored forgery-proof in a second memory unit is a program which reads out the identification data and, in combination with the data transmission protocol, establishes a connection with the network for the data exchange.

According to an advantageous embodiment, the module contains the second memory unit. The data for the identification of a user can indeed also be stored on the first memory unit. However, it is useful when a special second memory unit is provided for this. The second memory unit can be detachably connected with the module. A second interface for connection of the second memory unit can be provided for this. In this case, the second memory unit comprises a third interface corresponding to the second interface. The second memory unit can be, in particular, a part of a third interface corresponding to the second interface, which second interface has a SIM card. In this case, it is useful that the second interface be equipped with a first holder device for holding the SIM card. The first holder device can have a means of retaining the SIM card.

A SIM card is understood to mean a card which at least has a “Subscriber Identity Module” or a user identity module. The user identity module comprises a micro chip on which the identifying data of the user for a network operator are stored. The stored data can also be used to encrypt a voice or data transmission. Aside from this, personal data such as telephone numbers and similar can also be stored on the micro chip. Instead of the SIM card, Universal Integrated Circuit Cards (UICC) can also be used which, for example, support the Universal Subscriber Identity Module standard (USIM standard). This standard permits a combination of several user identity modules on one SIM card.

The second interface is usefully provided on a first holder device for holding the SIM card. The first holder device can be an opening in which to place the SIM card or a slit in which to insert the SIM card. The first holder device can have a means of retaining the SIM card. This can be a catch device, a movable bar, a lock or similar. Several first holder devices may also be provided for holding one SIM card each. The provision of several SIM cards permits, for example, an access to different data transmission networks, in particular mobile radio networks.

According to an advantageous embodiment, the multi-layer operating system comprises one layer with at least one driver program for the establishment of a connection with a peripheral device connected to the first interface. Several driver programs are usefully provided in the layer. The driver programs permit data exchange with a peripheral device connected via the first interface, for example, to a display, a keyboard or similar. If necessary, suitable driver programs can also be installed retroactively or downloaded from a provider, from the Internet, for example, via the wireless data exchange connection. According to a further embodiment, the multi-layer operating system comprises a further layer with at least one application program. It is useful when menu navigation for the selection of the application program from a plurality of application programs is provided. Furthermore, application kernels, in particular for the operation of a loudspeaker, microphone, monitor screen, a keyboard, a mouse, a printer, interfaces as well as other peripheral devices can be provided.

The data transmission protocol can be a standard protocol such as UMTS, GSM, Bluetooth, W-LAN, IR, AMPS, NMT, HSCSD, GPRS, EDGE and similar, for example. Of course it is also possible that the transmitting and receiving unit comprises several data transmission protocols. In this case, an especially universal data transmission is possible. For example, it is possible that the module or the transmitting and receiving unit comprises the following combinations of data transmission protocols:
UMTS, GSM,
UMTS, Bluetooth,
UMTS, Bluetooth, W-LAN, IR.

“UMTS” is understood to mean a universal mobile telecommunications system. It is the third-generation mobile communications technology (3G) with which data transmission speeds of up to 2 Mbit/se (Mbs) are possible.

“GSM” (Global System for Mobile Communication) is understood to mean a global system for mobile communication. It is the predominant 2G-standard of digital telecommunication. This system determines how mobile telephones communicate with one another via a land-supported network of transmitters/receivers.

“Bluetooth” is understood to mean a technology for the creation of a cable-free network with a smaller range. Particularly cable-free peripheral devices such as microphones, printers, loudspeakers and similar can be connected with this to a data processing unit.

“W-LAN” (Wireless Local Area Network) is understood to mean a wireless local network. The W-LAN technology provides high-speed data connections between mobile data devices such as laptops, mobile telephones and PDAs and similar, with shorter ranges in the vicinity of so-called Wi-Fi access points. Wi-Fi access points are special hardware which is connected with the cable-connected network.

“AMPS” (Advanced Mobil Phone Service) is understood to mean the 1 G standard which is operated on the 800 to 900 MHz frequency band.

“NMT” (Nordic Mobil Telephone) is understood to mean the earliest 1 G standard which is operated on the 450 as well as on the 900 MHz band.

“HSCSD” (High Speed Circuit Switched Data) is understood to mean a data transmission technology for GSM during which the data transmission is up to 14.4 Kbps on a single channel. By connecting several channels together data transmission speeds can be increased to up to 57.6 Kbps.

“GPRS” (General Paket Radio Service) is understood to mean a radio technology for GSM networks using packet-switching protocols.

“EDGE” (Enhanced Data Rates for GSM Evolution) is understood to mean an enhanced modulation technology with which the network capacity and the data speeds in GSM networks can be increased.

The suggested module enables the establishment of a contact to a network via the transmitting and receiving unit provided therein and thus data exchange with the network.

According to an advantageous embodiment, a first mounting device is provided for detachable mounting of the first memory unit. Likewise a second mounting device can also be provided for the detachable mounting of the transmitting and receiving unit. The aforementioned mounting devices can be conventional bases for holding the chips which provide the first memory unit or the transmitting and receiving unit. By exchanging such chips the user can easily adapt the module to new requirements.

According to a further embodiment, it is provided that the transmitting and receiving unit comprises a second central processor unit CPU2. This enables a particularly quick data exchange at a high speed. Aside from this the data can be encrypted particularly quickly.

According to a further embodiment, it is provided that CPU1, the first memory unit, if necessary, the second memory unit and the transmitting and receiving unit are cast with a polymer. This makes the suggested module particularly robust. This makes the module particularly resistant to moisture, jolts and similar. The module can be made in one piece. In other words it represents a compact component to which, aside from a possible means of holding a SIM card, no other elements are mounted via mounting means. It has been shown to be useful when the module is made in a cuboid shape whose length and width is a maximum of 6 cm and whose height is a maximum of 1 cm. This enables universal combination of the module with a wide variety of peripheral devices.

It has shown to be useful that the module made insofar from one piece can be provided with a coating which protects it from electromagnetic waves at least in sections on its outside. This enables interference-free operation of the module. It is particularly resistant to electromagnetic interference.

According to a further embodiment, a power supply unit can be provided. The power supply unit can comprise a battery or a rechargeable battery. This enables active operation of the module even without connection to a peripheral device. In this case, the module can receive or transmit data independently. For this purpose, it is useful that the module be provided with an antenna.

According to a further advantageous embodiment, it is provided that the first interface is shaped in the form of a plug connector. The plug connector is advantageously a row of adjacent contacts for the connection to a peripheral device.

According to further provision of the invention, a peripheral device is provided with a fourth interface corresponding to the first interface for the establishment of a plug connection with the module provided by the invention. The peripheral device enables data exchange with the module via the fourth interface. The module can also be part of the peripheral device.

According to an embodiment, the fourth interface is provided in a second holder device for holding the module. The second holder device can be an opening in the form of a recess or a slot for insertion of the module.

According to a further embodiment, the second holder device is shaped corresponding to the plug connection. In other words, the holder device corresponds to the shape of the module and has, for example, grooves, ridges or runners or similar to guide the module to a correct connection position of the first with the fourth interface. In this case, the module is largely positively held in the second holder device. According to a further embodiment, the second holder device is equipped with a means of retaining the module. This can be a lock or catch mechanism and/or a device for ejecting the module from an insertion slot.

It has been shown to be useful that the peripheral device has a further power supply unit. This can in turn be a battery or a rechargeable battery but also a power pack. Furthermore, the peripheral device can have a further antenna. In addition, the peripheral device can have a housing with a user interface. The user interface can be a keypad or a touch display on which the functions or entries can be made, for example, by recording or touching with a stick. The housing can preferably have a swivel-type display.

According to a particularly advantageous embodiment, the housing is shaped like a mobile telephone. In this case, it can comprise a keypad, a display, a microphone, a loudspeaker and a power supply device.

In contrast, all other components of the mobile telephone combined in the module provided by the invention which can be combined into a mobile telephone by simply inserting it into the housing. In this way, relatively inexpensive housings can be provided for mobile telephones. These housings can be combined without great effort with the module provided by the invention into a mobile telephone. This is particularly advantageous when the module provided by the invention is equipped with a powerful and expensive transmitting and receiving device, for example, a UMTS transmitting and receiving device. In this case, the module provided by the invention can be combined into a mobile telephone. However, it is also possible to use the module for connection, for example, of a laptop computer to the Internet or another data network.

Personal data stored on the module must no longer be synchronized. The module is universal and can use the popular devices for transmitting and receiving data. To this extent it is also possible that the peripheral device is a monitor. By connecting a keyboard to the monitor, data can be transmitted and received. In particular, communication with the Internet, for example, is possible with this.

According to a particularly advantageous further embodiment, the module is equipped with a conventional socket for the connection of a keyboard and/or a mouse. In combination with a monitor, this makes it easy and convenient to control the multi-layer operating system provided on the module.

The module can comprise a VGA interface, for example, for combination of the module with a monitor. In a similar way, the module can comprise suitable interfaces, for example, an IR interface or similar for combination with other peripheral devices.

Furthermore, an adapter can be provided for connection of the module with a fourth interface corresponding to the first interface. In addition, the adapter has a seventh interface for the connection of the module to an eighth interface corresponding to the seventh interface on a peripheral device. The eighth interface can be a standard interface, for example, a PCMCIA or a USB interface. This enables communication of the module with a peripheral device via conventional interfaces.

Examples will now be used to describe the embodiments of the invention in more detail based on the drawings. The figures are listed below:

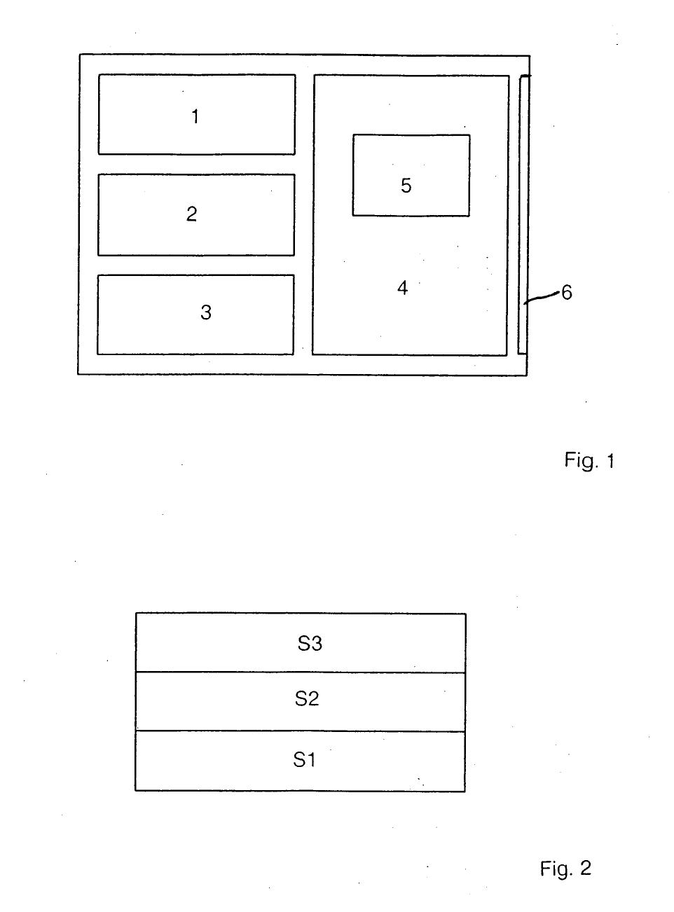

FIG. 1 a schematic presentation of the components of the module,

FIG. 2 a schematic presentation of a multi-layer operating system,

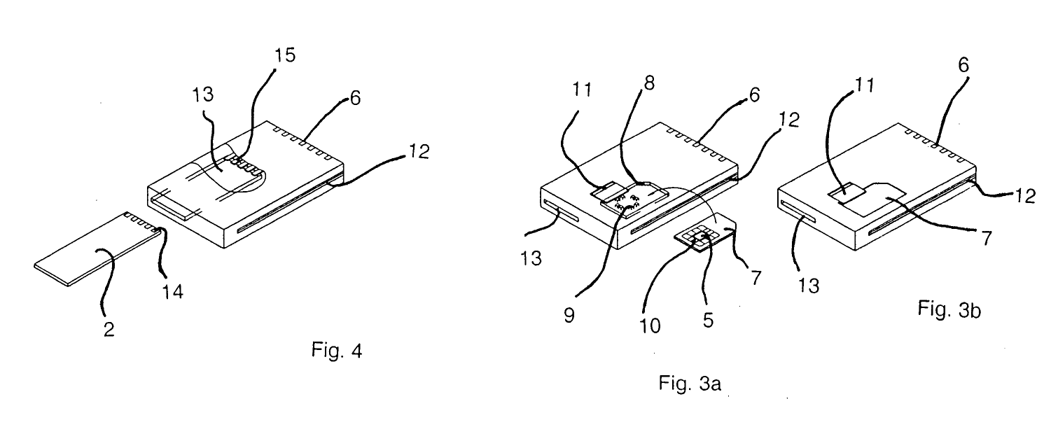

FIG. 3 a first embodiment of the module,

FIG. 4 a second embodiment of the module,

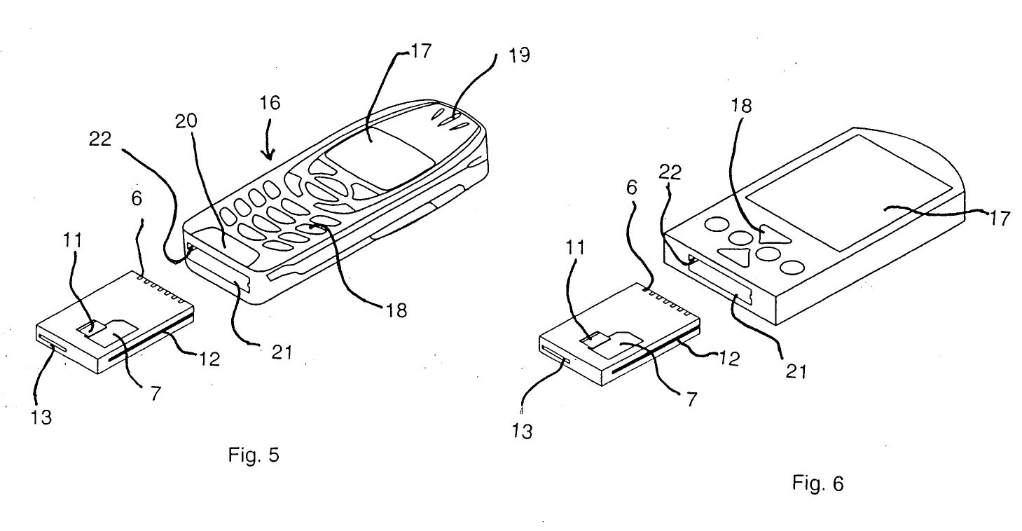

FIG. 5 the module as per FIG. 4 in combination with a mobile telephone,

FIG. 6 the module as per FIG. 4 in combination with a PDA,

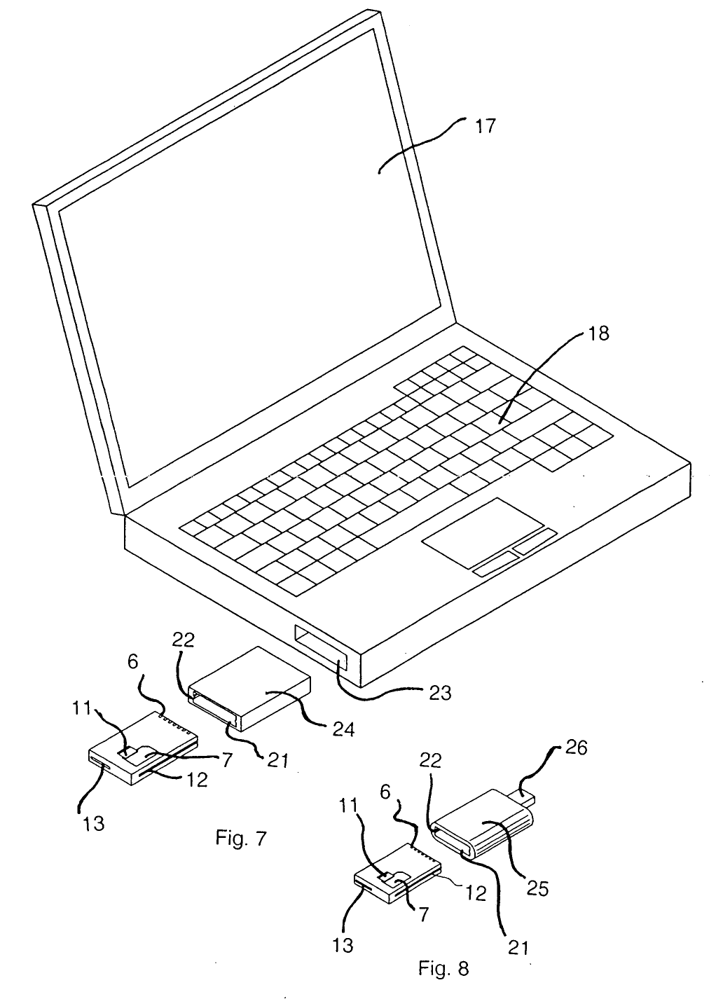

FIG. 7 the module as per FIG. 4 in combination with a first adapter and a portable computer and

FIG. 8 the module as per FIG. 4 in combination with a second adapter.

FIG. 1 schematically shows an example of the module provided by the invention. The module comprises a central processor unit (CPU1), a transmitting and receiving unit 2 for wireless transmitting and receiving of data, a first memory unit 3 as well as a SIM unit 4 with a second memory unit 5 which can, for example, be part of a SIM card 7. Furthermore, a first interface 6 is provided.

A multi-layer operating system is stored on the first memory unit 3. As is particularly shown in FIG. 2, the multi-layer operating system has several layers S1, S2 and S3. A first layer S1 is an operating system for the control of the hardware components. A second layer S2 is a service level which is usually not accessible to the user. It enables adaptation of the operating system to the respective hardware components being used. A third layer S3 then provides a user interface with which a user can enter, delete or change data and settings on the operating system. The user interface usually has menu navigation which simplifies handling for the user.

FIGS. 3a and 3b show a view in perspective of a first embodiment of a module. The second memory unit 5 is provided on a SIM card 7. The module has an opening 8 corresponding to the form of the SIM card 7. The opening 8 contains a second interface 9 for the connection of a third interface 10 corresponding to the SIM card 7. As is particularly shown in the combination view with FIG. 3b, the SIM card 7 is retained in the opening 8 with a movable bar 11.

The module has the shape of a flat cuboid with a height of a maximum of 1 cm. Guide grooves 12 are provided on the longitudinal side. As is shown particularly clearly in the combination view with FIG. 4, stretching along a front side is a first slot 13 for insertion, for example, of a card containing the transmitting and receiving unit 2 or the first memory unit 13. A fifth interface indicated with reference designator 14 of the correspondingly formed sixth interface indicated with the reference designator 15 and provided in the first slot 13. Since, for example, the exchange of the transmitting and receiving unit 2 is provided on a card, the module provided by the invention can be quickly and easily adapted to the respective needs of the user. For example, the card can comprise a UMTS, a GSM, Bluetooth or similar transmitting and receiving unit 2.

In the second example shown in FIG. 4 the second memory unit 5 is not part of a SIM card 7. It is integrated here in the module.

FIG. 5 shows a view in perspective of a first peripheral device, namely a housing 16 for a mobile telephone. The housing 16 is equipped with a display 17, a keypad 18, a loudspeaker 19, a microphone 20 as well as a second slot 21 which is formed corresponding to the exterior shape of the module. The second slot 21 has guide rails 22 which correspond particularly to the guide grooves 12. The second slot 21 contains a (not shown here) second interface 9 corresponding to the first interface 6. When the module is fully inserted in the second slot 21, an electrical connection is established between the contacts of the first interface 6 and the second interface 9. Catch or locking mechanisms which are not shown in detail here can be provided to retain the module inside the second slot 21.

FIG. 6 shows a view in perspective of a second peripheral device. This is a PDA which also has a keypad 18 and a display 17. Also here the second slot 21 is formed identically with the second slot 21 for the first peripheral device shown in FIG. 5.

FIG. 7 shows a view in perspective of a third peripheral device, namely a portable computer or laptop computer. An interface usually provided on such a computer, for example a PCMCIA interface, can be used to hold the module provided by the invention via a suitable first adapter 24. The first adapter 24 in turn has the second slot 21, the guide rails 22 as well as the (not shown here) second interface 9.

Furthermore, the first adapter 24 has a (not shown here) seventh interface with which it can be connected to an eighth interface of the PCMCIA interface provided correspondingly in the third slot 23.

As shown in FIG. 8, the module provided by the invention can also be connected with a USB interface, for example. An appropriately formed second adapter 25 with a plug connector 26 is provided for this for the connection to a USB interface.

As is shown from the aforementioned examples, the suggested module can work together universally with a wide variety of peripheral devices. It not only gives the peripheral device the function of a wireless transmitter and receiver of data but also provides a multi-layer operating system which, among others, enables a controller. Control of the module by a user only requires that the module be combined with a user interface, for example, a keypad 18 and a display 17.

The module can be provided with a rechargeable power supply unit. An appropriate connection for a battery charging device can be provided to recharge the power supply device. Aside from this, the module can also be provided with connections for a keyboard and a mouse. In this case, the module can be combined, for example, with a flat monitor screen provided as a further peripheral device and when a keyboard and/or a mouse is connected, the combination of module and peripheral device can be controlled.

To the extent that the module is equipped with a power supply device, it can also transmit and receive data independently without connection to a peripheral device. The module can thus receive and store SMS messages, voice messages or similar, for example. Likewise it is also conceivable that the module could be used in combination with suitable sensors for monitoring body functions of a user. If certain body functions reach a specified critical value, data can be automatically transmitted, for example, to a remote receiving unit on which an appropriate alarm is indicated. This can be used to recognize a poor bodily state of a user carrying the module. In combination with a GPS transmitting and receiving unit 2, the position of the user can also be determined so that help can be provided quickly.

### Reference Sign List

1 Central processor unit CPU1

2 Transmitting and receiving unit

3 First memory unit

4 SIM unit

5 Second memory unit

6 First interface

7 SIM card

8 Opening

9 Second interface

10 Third interface

11 Bar

12 Guide groove

13 First slot

14 Fifth interface

15 Sixth interface

16 Housing

17 Display

18 Keypad

19 Loudspeaker

20 Microphone

21 Second slot

22 Guide rail

23 Third slot

24 First adapter

25 Second adapter

26 Plug connector

S1 First layer of an operating system

S2 Second layer of an operating system

S3 Third layer of an operating system

1. Module for data transmission with
a first central processor unit CPU1 (1),
a first memory unit (3) working together with the CPU1 (1) with a multi-layer operating system (S1, S2, S3),
a first mounting device for detachable mounting of the first memory unit (3)
an antenna and a transmitting and receiving unit (2) for wireless and independent data exchange with a network comprising a plurality of further transmitting and receiving units,
wherein the transmitting and receiving unit (2) comprises a specified data transmission protocol which requires identification data stored forgery-proof in a second memory unit (5) for the identification of a user in the network,
a power supply unit and
a first interface (6) suitable for the establishment of a plug connection for connection to a peripheral device.

2. Module as defined in claim 1, containing the second memory unit (5).

3. Module as defined in claim 1, wherein a second interface (9) is provided for the connection of the second memory unit (5).

4. Module as defined in claim 1, wherein the second memo, unit (5) is part of a SIM card (7) which has a third interface (10) corresponding to the second interface (9).

5. Module as defined in claim 1, wherein the second interface (9) is provided on a first holder device (8) for holding the SIM card (7).

6. Module as defined in claim 1, wherein the first holder device (9) has a means (11) of retaining the SIM card (7).

7. Module as defined in claim 1, wherein the multi-layer operating system comprises one layer with at least one driver program for the establishment of a connection with a peripheral device connected to the first interface.

8. Module as defined in claim 1, wherein the multi-layer operating system comprises a further layer with at least one application program.

9. Module as defined in one of the preceding claim 1, wherein menu navigation is provided for the selection of the application program from a plurality of application programs.

10. Module as defined in claim 1, wherein the data transmission protocol corresponds to a standard protocol selected from the following group: UMTS, GSM, Bluetooth, W-LAN, IR, AMPS, NMT, HSCSD, GPRS, EDGE.

11. Module as defined in claim 1, wherein a second mounting device is provided for the detachable mounting of the transmitting and receiving unit (2).

12. Module as defined in claim 1, wherein the transmitting and receiving unit (2) comprises a second central processor unit CPU2.

13. Module as defined in claim 1, wherein the CPU1 (1), the first memory unit (3), if necessary the second memory unit (5), and the transmitting and receiving unit (2) are cast with a polymer.

14. Module as defined in claim 1, wherein it is formed in the shape of a cuboid whose length and width is a maximum of 6 cm and whose height is a maximum of 1 cm.

15. Module as defined in claim 1, wherein the module is provided with a coating for shielding from electromagnetic waves at least in sections on its exterior side.

16. Module as defined in claim 1, wherein it is made from one piece.

17. Module as defined in claim 1, wherein the power supply device comprises a battery or a rechargeable battery.

18. Module as defined in claim 1, wherein the first interface (6) is formed in the shape of a plug connector (26).

19. Peripheral device with a fourth interface corresponding to the first interface (6) for the establishment of a plug connection with the module as defined in claim 1.

20. Peripheral device as defined in claim 19, wherein the fourth interface on a second holder device (21) is provided for holding the module.

21. Peripheral device as defined in claim 20, wherein the second holder device (21) is formed corresponding to plug connector (26).

22. Peripheral device as defined in one of the claim 20, wherein the second holder device (21) has a means of retaining the module.

23. Peripheral device as defined in one of the claim 19, wherein it has a further power supply device.

24. Peripheral device as defined in claim 23, wherein the further power supply device comprises a battery or a rechargeable battery.

25. Peripheral device as defined in claim 19, wherein it has a further antenna.

26. Peripheral device as defined in claim 19, wherein it has a housing (16).

27. Peripheral device as defined in claim 26, wherein a preferably swivel display (17) and/or a user interface (18) is/are provided on the housing (16).

28. Peripheral device as defined in claim 26, wherein the housing (16) is formed like a mobile telephone.

29. Peripheral device as defined in claim 19, wherein the peripheral device is a computer or a monitor.

30. Adapter with a fourth interface corresponding to the first interface (6) and a seventh interface (26) formed as a plug connector for the connection of the module as defined in claim 1 to an eighth interface corresponding to the seventh interface (26) on a peripheral device (16, 18)

31. Adapter as defined in claim 30, wherein the eighth interface is a PCMCIA or USB interface.
